(19) United States
(12) Patent Application Publication
(10) Pub. No.: US 2026/0166790 A1
(43) Pub. Date: Jun. 18, 2026

(54) METHOD FOR FORMING PFA COATED BUTTERFLY PLATE WITHOUT FLOW MARKS

(71) Applicant: NANJING COMPTECH COMPOSITES CORP., Nanjing (CN)

(72) Inventors: Keyuan SUN, Nanjing (CN); Wenguang YANG, Nanjing (CN); Yan XIA, Nanjing (CN); Haifei WANG, Nanjing (CN); Ye YANG, Nanjing (CN); Xiaogang WANG, Nanjing (CN); Zhaoxi CHEN, Nanjing (CN); Kai LIU, Nanjing (CN); Yisu XIAO, Nanjing (CN)

(73) Assignee: NANJING COMPTECH COMPOSITES CORP., Nanjing (CN)

(21) Appl. No.: 19/125,334

(22) PCT Filed: May 4, 2023
(86) PCT No.: PCT/CN2023/092063

§ 371 Date: Apr. 29, 2025

(30) Foreign Application Priority Data
Nov. 1, 2022 (CN) 202211354600.9

(51) Int. Cl. B29C 45/73; B29C 45/26; B29C 45/33; B29C 45/64; B29C 70/46

(52) U.S. Cl. CPC B29C 45/7337; B29C 45/2669; B29C 45/332; B29C 45/64; B29C 70/467

(57) ABSTRACT

The patent discloses a method for forming a PFA coated butterfly plate without flow marks, comprising a mold and a plate core; the mold comprises a push mold, a hopper, an upper mold, and a lower mold; the bottom of the upper mold is equipped with an upper cavity, the top of the lower mold is equipped with a lower cavity, and the upper mold has an injection port. There are two symmetrical protruding structures on the board core, both of which are connected to shafts. Both the board core and the shaft have interconnected channels that run through the center of the board core. The forming method of PFA coated butterfly board is to cover a layer of PFA on the outer surface of the board core, which can ensure that the prepared product has no texture.

### CROSS REFERENCE OF RELATED APPLICATION

This is a U.S. National Stage under 35 U.S. C 371 of the International Application PCT/CN 2023/092063, filed May 4, 2023, which claims priority under 35 U.S.C. 119(a-d) to CN 202211354600.9, filed Nov. 01, 2022.

### FIELD OF THE INVENTION

The present invention belongs to the field of special valves for high-corrosion-resistant media, and particularly relates to a method for forming none gas-textured PFA coated butterfly plate.

### BACKGROUND OF THE INVENTION

The butterfly valve with plastic coating on the surface belongs to the field of special valves for strong-corrosion-resistant media, and the butterfly plate in the butterfly valve with plastic coating on the surface rotates along with the valve rod as an opening and closing member for opening, closing and adjusting the valve, and has reliable hydrochloric acid, hydrofluoric acid, chlor-alkali and other strong corrosive media and sealing performance. The product can be widely used in chlorine-alkali chemical industry, PVC, organic silicon, fluorosilicone, metallurgical acid pickling, petrochemical industry, papermaking, electric power, pharmaceutical, pesticide, environmental protection and other strong corrosive media.

Since the corrosion resistance and the compressive deformation capability of the sealing surface need to be ensured, the butterfly plate (i.e. the plate core) in the butterfly valve with plastic coating on the surface generally needs to cover the corrosion-resistant material (most of the fluororesin such as PTFE), thereby ensuring that the valve can resist strong acid, strong base and strong corrosive medium, and it is ensured that the valve has a sealing effect after being repeatedly opened and closed.

The butterfly plate (i.e. the plate core) in the butterfly valve needs to be connected with the valve shaft or the valve rod, so that the function of adjusting opening and closing is achieved, and when the valve shaft or the valve rod is connected with the two sides of the plate core or the valve rod on the plate core through the position, due to the fact that the melt viscosity is large, the melt cooling shrinkage process peripheral melt is first cooled, the compressed gas close to the plate core protruding part is not easy to discharge, during the cooling and shrinkage process of the melt, a large area of texture is generated in the coating layer on the outer surface of the plate core, the adhesion and later processing size stability of the coating layer are affected, the local pressure receiving capacity and the dimensional stability after the sealing surface is pressed are reduced, and therefore the service life is affected.

Generally, in order to reduce texture during injection molding of thermoplastic materials and products, methods such as increasing mold temperature, increasing molding pressure, optimizing injection speed, and increasing exhaust gaps are used. ; however, PFA (soluble polytetrafluoroethylene) has a large melt viscosity, and because the shape of the plate core belongs to an insert having a relatively large width and thickness, a protruding structure is provided, the central texture (i.e. flow marks) cannot be completely eliminated by purely adopting process optimization, and the problems of incomplete coating, insufficient size, insufficient coating thickness and the like of the plate core may also occur.

The butterfly plate with PFA coating on the surface is coated with PFA on a butterfly plate (i.e. a plate core), and the PFA-coated butterfly plate has the advantage of corrosion resistance of PTFE ; the transparency of the coating layer is good, and it is easier to detect internal cracks and defects in the board core compared to PTFE coated butterfly plates ; the thickness of the coating layer can be made thinner, and the loss of the material can be reduced; the coating can be formed at a time, and has small machining allowance than PTFE; the coating thickness is uniform, and the coating is not easy to crack; the long-term use temperature is up to 200-260° C. the coating has a self-lubricating effect, a small friction coefficient, and a small torsion moment of the butterfly plate.

Therefore, a method for forming a new PFA coated butterfly plate is provided, so that the plate core coated with PFA has no flow marks, which is a problem that needs to be solved at present.

### SUMMARY OF THE INVENTION

The technical problem to be solved by the present invention is to provide a method for forming a PFA coated butterfly plate without flow marks according to the above-mentioned defects in the prior art, the method for forming the PFA coated butterfly plate without flow marks is to coat a layer of PFA on the outer surface of the plate core, and it can be ensured that the prepared product has no flow marks.

In order to achieve the above technical purpose, the technical solution adopted by the present invention is:
a method for forming a PFA coated butterfly plate without flow marks, comprising a mold and a plate core;
the mold comprises a push mold, a hopper, an upper mold and a lower mold; the bottom of the upper mold is provided with an upper cavity, the top of the lower mold is provided with a lower cavity, the upper mold is internally provided with an injection port, the injection port penetrates through the top of the upper mold and the middle of the upper cavity of the upper mold, when the hopper is located on the upper mold, the outlet of the hopper is communicated with the injection port of the upper mold, and the push mold is arranged in the hopper for pushing the material in the hopper;
two mutually symmetrical protruding structures are arranged on the plate core, shafts are connected to the two protruding structures, the two shafts are located on the same straight line, channels communicating with each other are formed in the plate core and the shaft, and the channel penetrates through the center of the plate core;
the forming method includes the following steps:
a plate core is taken, a first through hole penetrating through the upper surface and the lower surface of the plate core is formed in the center of the plate core, the first through hole is communicated with a channel in the plate core, an expanded polytetrafluoroethylene cylindrical block is inserted into the first through hole, and a plurality of second through holes penetrating through the upper surface and the lower surface of the plate core are further formed in other positions of the plate core,
placing the plate core into the lower cavity of the lower mold, placing the shaft connected on the plate core outside the lower cavity and connected to the top of the lower mold, placing the upper mold on the lower mold, the plate core being located in the upper cavity of the upper mold, connecting the upper mold to the lower mold, the shaft on the plate core being clamped between the upper mold and the lower mold, and the gap between the upper cavity of the upper mold and the plate core and the gap between the lower cavity of the lower mold and the plate core being the thickness of PFA needing to be coated on the surface of the plate core;
the hopper is connected to the upper mold, the outlet of the hopper is in communication with the injection port of the upper mold, the overall structure assembled by the hopper, upper mold, lower mold and plate core is heated to melt the PFA raw material in the hopper, and after the heating is finished, the push mold is placed in the hopper of the overall structure, the pressing machine performs hot pressing on the push mold, and the push mold applies pressure to the material in the hopper, so that the PFA raw material in the hopper flows into the injection port of the upper mold, the gap between the upper cavity of the upper mold and the plate core, the second through holes and the gap between the lower cavity of the lower mold and the plate core;
after the hot pressing is finished, cooling the mold and the plate core, connecting the channel in the shaft connected with the plate core to the outer connecting pipe after the plate core falls to the preset temperature, vacuumizing the outer connecting pipe, and pumping out the gas between the PFA raw material and the plate core through the expanded polytetrafluoroethylene cylindrical block, the channel in the plate core, the channel in the shaft and the outer connecting pipe in sequence, and disassembling the outer connecting pipe;
after the plate core is cooled to a certain temperature, the mold and the plate core are integrally cooled, the upper mold and the lower mold at the outer side of the plate core are removed after cooling, the residual PFA at the injection port is removed, and PFA coated on the outer surface of the plate core is trimmed and polished to obtain the PFA coated butterfly plate.

As a further improved technical solution of the present invention, the two protruding structures on the plate core are of a solid structure, the protruding structures on the plate core and the shaft are of an integrated structure, and a channel in the plate core penetrates through the protruding structure and then communicates with a channel in the shaft.

As a further improved technical solution of the present invention, the inner sides of the two protruding structures on the plate core are provided with mounting holes, the shaft is a tool shaft, the two tool shafts are respectively inserted into the mounting holes of the two protruding structures on the plate core, and the first through hole in the plate core are communicated with the channel in the tool shaft through the channel on the plate core and the mounting hole of the protruding structure on the plate core.

As a further improved technical solution of the present invention, the first through hole and the second through holes are both circular holes with a diameter of 5-20 mm.

As a further improved technical solution of the present invention, the PFA solid raw material is PFA granular material or powder, the melting point is 305-310° C. the melt index is greater than or equal to 2 g/10 min, and the density is 2.13-2.15 g/cm³.

As a further improved technical solution of the present invention, the heating of the overall structure assembled by the hopper, the upper mold, the lower mold and the plate core is specifically as follows:
the overall structure of the hopper, the upper mold, the lower mold and the plate core is placed into an oven for heat preservation for a period of time, the temperature of the oven is 320-380° C. and the heat preservation time is 2-5 h.

As a further improved technical solution of the present invention, the press uses a pressure of 6-10 MPa to perform hot pressing on the pushing mold.

As a further improved technical solution of the present invention, after the hot pressing is finished, the mold and the plate core are cooled, and after the plate core is reduced to 310° C. to 315° C. the channel in the shaft connected to the plate core is connected to the outer connecting pipe to vacuumize the outer connecting pipe.

As a further improved technical solution of the present invention, the temperature of the plate core is reduced below 260° C. and the mold and the plate core are integrally cooled.

As a further improved technical solution of the present invention, the porosity of the expanded polytetrafluoroethylene cylindrical block is greater than or equal to 30%, the upper end face and the lower end face of the expanded polytetrafluoroethylene cylindrical block are both arc convex faces, the upper end face of the expanded polytetrafluoroethylene cylindrical block protrudes from the end face of the first through hole of the plate core, and the lower end face of the expanded polytetrafluoroethylene cylindrical block protrudes from the other end face of the first through hole of the plate core.

The beneficial effects of the present invention are as follows:
1. According to the present invention, the first through hole is formed in the plate core, the expanded polytetrafluoroethylene cylindrical block is inserted into the first through hole, the expanded polytetrafluoroethylene cylindrical block can resist high temperature and do not melt, metal and PFA are not sticky, the strength is small, and the expanded polytetrafluoroethylene cylindrical block is taken out after being crushed, and the air flow can be allowed to pass through in the vacuumizing stage of the forming process without passing the PFA melt.
2. According to the present invention, the plate core is provided with a plurality of second through holes, the number of the second through holes is determined according to the size and the arrangement, and during hot pressing, it is ensured that the material is stably injected into the lower cavity of the lower mold from the second through holes.
3. In the present invention, a press is used to perform hot pressing on the push mold, so that the PFA melt flows into the injection port of the upper mold, the gap between the upper cavity of the upper mold and the plate core, the second through holes, and the gap between the lower cavity of the lower mold and the plate core ; Then, the plate core is cooled, after the temperature of the plate core is reduced to 310° C. to 315° C. a vacuum is performed at the plate core, air between the PFA melt and the plate core is pumped out, and a portion of the compressed gas close to the plate core protruding portion is pumped out. The cooling continues, followed by de-molding. It is guaranteed that no flow marks exists between the manufactured plate core and the PFA coating layer, the PFA coating layer can completely cover the plate core, and the thickness of the PFA coating layer is 3-10 mm
4. The upper end face and the lower end face of the expanded polytetrafluoroethylene cylindrical block are both arc convex faces and protrude from the end face of the first through hole of the plate core, and during vacuumizing, the circular arc convex face of the expanded polytetrafluoroethylene cylindrical block facilitates air flow and extraction.

### BRIEF DESCRIPTION OF THE DRAWINGS

FIG. 1 is a top view of a plate core provided with a first through hole and a second through holes in Embodiment 1.

FIG. 2 is a cross-sectional view of the plate core provided with the first through hole and the second through holes in Embodiment 1.

FIG. 3 is a cross-sectional view of the mold in Embodiment 1 after being matched with the plate core and along a direction in which the protrusion structure is located.

FIG. 4 is a cross-sectional view of the mold in Embodiment 1 after being matched with the plate core and along the direction of the first through hole and the second through holes.

FIG. 5 is a top view of the plate core coated with PFA in Embodiment 1.

FIG. 6 is a cross-sectional view of the plate core coated with PFA and along the direction of the first through hole and the second through holes in Embodiment 1.

FIG. 7 is a cross-sectional view of the plate core coated with PFA and along the direction of the protrusion structure in Embodiment 1.

FIG. 8 is a top view of the plate core provided with the first through hole and the second through holes in Embodiment 2.

FIG. 9 is a cross-sectional view of the mold in Embodiment 2 after being matched with the plate core and along a direction in which the protrusion structure is located.

FIG. 10 is a top view of the plate core coated with PFA in Embodiment 2.

FIG. 11 is a cross-sectional view of the plate core coated with PFA and along the direction of the protrusion structure in Embodiment 2.

### DETAILED DESCRIPTION OF SOME EMBODIMENTS

Specific embodiments of the present invention are further described below according to the accompanying drawings.

In order to ensure the corrosion resistance and the compressive deformation capability of the sealing surface, the butterfly plate needs to coat the PFA corrosion-resistant material, and the existing butterfly plate comprises two structures: (1) the butterfly plate (also referred to as the plate core 1) is provided with two mutually symmetrical protruding structures 2, the two protruding structures 2 are solid structures, and the two protruding structures 2 are integrally connected to the shaft 3 (the shaft 3 is a valve shaft), (2) Two mutually symmetrical protruding structures 2 are arranged on the butterfly plate, mounting holes 15 are formed in the inner sides of the two protruding structures 2, and the valve shafts are inserted into the mounting holes 15 of the two protruding structures 2. The following describes specific embodiments 1 and 2 for butterfly valves of two structures.

### Embodiment 1

A method for forming a PFA coated butterfly plate without flow marks, comprising a mold and a plate core 1, the circular plate core 1 is made of a metal material such as cast iron or steel. The mold is made of a metal material.

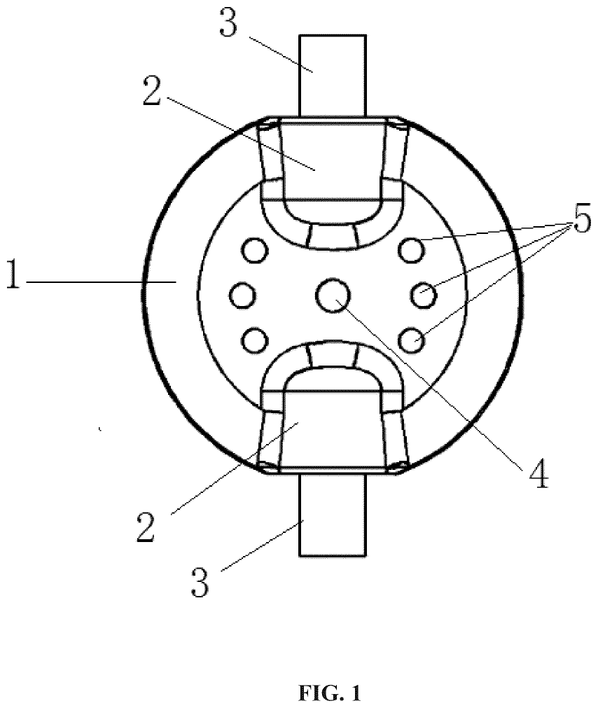

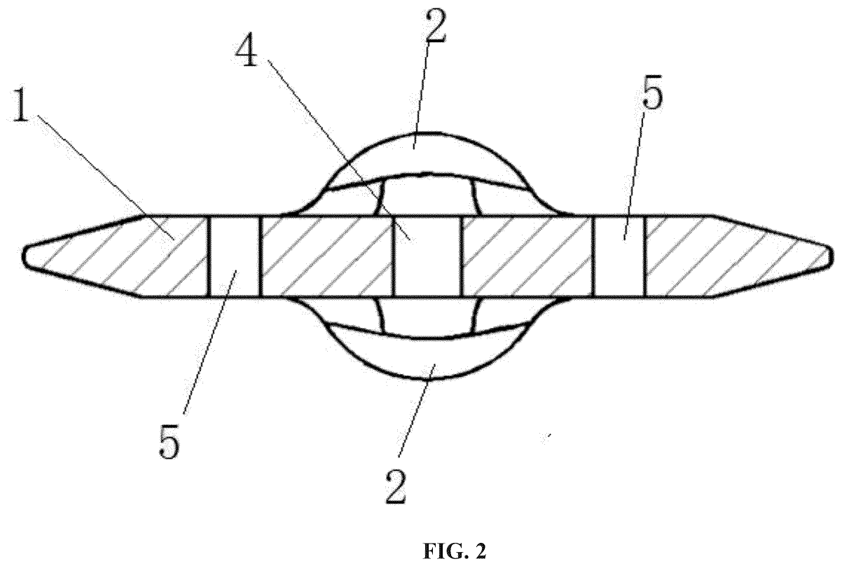

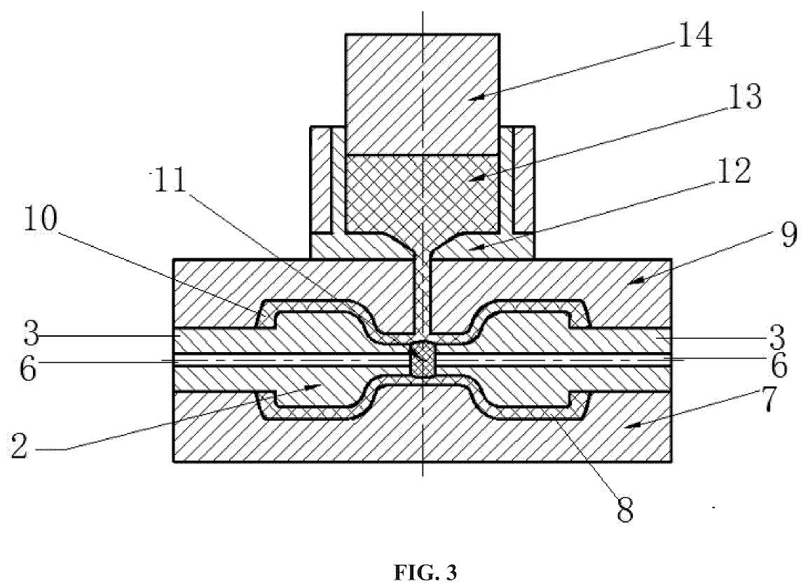

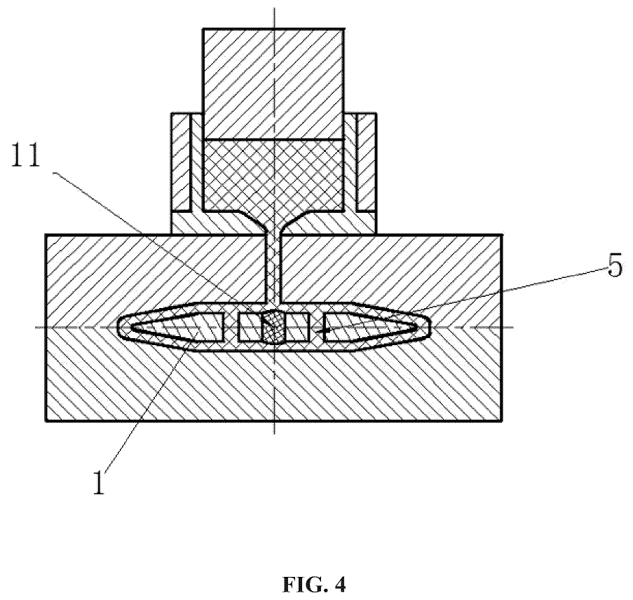

As shown in FIGS. 3 and 4, the mold includes a push mold 14, a hopper 12, an upper mold 9 and a lower mold 7 ; The bottom of the upper mold 9 is provided with an upper cavity 10, the top of the lower mold 7 is provided with a lower cavity 8, the upper mold 9 is internally provided with an injection port, the injection port penetrates through the top of the upper mold 9 and the middle of the upper cavity 10 of the upper mold 9, the outlet of the hopper 12 is communicated with the injection port of the upper mold 9 when the hopper 12 is located on the upper mold 9, and the push mold 14 is placed in the hopper 12 and used for pushing the material in the hopper 12. As shown in FIGS. 1 and 2, the plate core I is provided with two mutually symmetrical protruding structures 2, the two protruding structures 2 are solid structures, the two protruding structures 2 are both connected to the shaft 3, the two shafts 3 are located on the same straight line, and the shaft 3 and the protruding structure 2 are of an integrated structure. The plate core 1 and the shaft 3 are each provided with a channel 6 communicating with each other, and the channel 6 penetrates through the protrusion structure 2 of the plate core 1 and the center of the plate core 1.

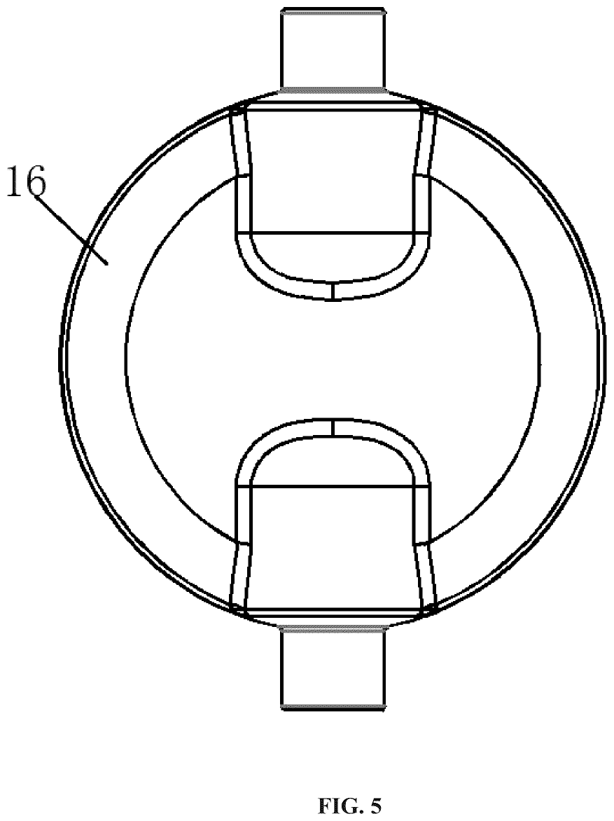

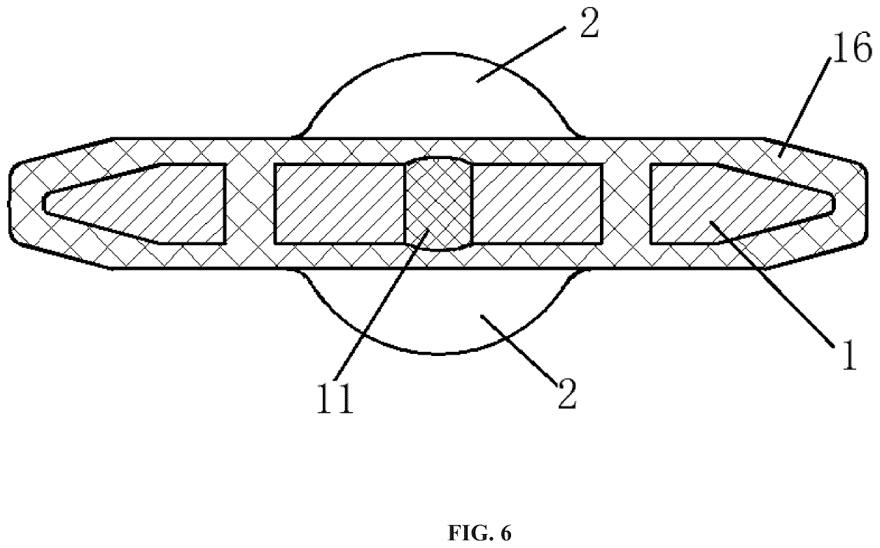

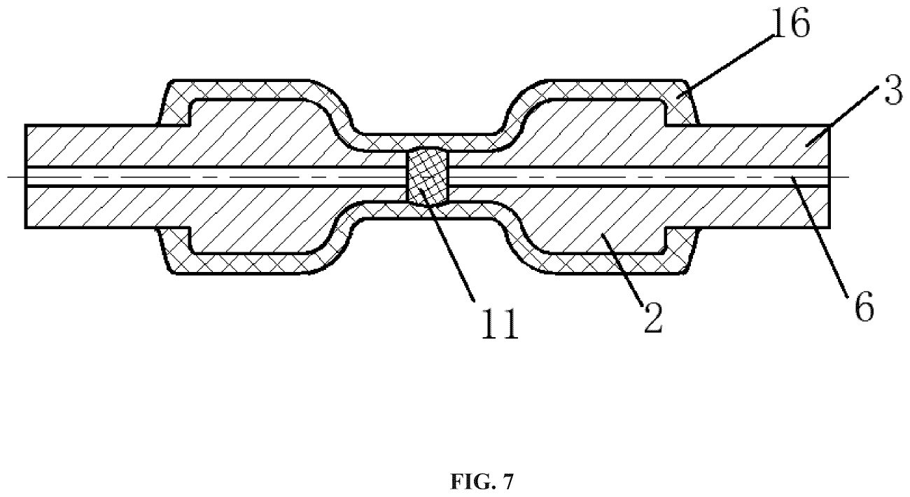

The forming method includes the following steps:
(1) A plate core 1 is taken, as shown in FIG. 1 and FIG. 2, the first through hole 4 penetrating through the upper surface and the lower surface of the plate core 1 is formed in the center of the plate core 1, ensuring that the first through hole 4, the channel 6 in the plate core 1, and the channel 6 in the shaft 3 are connected in sequence, the first through hole 4 is filled with the expanded polytetrafluoroethylene cylindrical block 11. The expanded polytetrafluoroethylene cylindrical block 11 can withstand high temperatures without melting, does not stick to metals and PFA, has low strength and is easy to crush, during the vacuum stage of the forming process, airflow can be allowed to pass through without allowing PFA melt 13 to pass through. The porosity of the expanded polytetrafluoroethylene cylindrical block 11 is greater than or equal to 30%, and the other positions of the plate core 1 are further provided with a plurality of second through holes 5 penetrating through the upper surface and the lower surface of the plate core I.
(2) The plate core 1 is placed into the lower cavity 8 of the lower mold 7, the shaft 3 connected to the plate core 1 is placed outside the lower cavity 8 and is positioned and connected to the top of the lower mold 7 to prevent the board core 1 from moving left and right along the axis of shaft 3 and swinging around the axis of shaft 3, the upper mold 9 is placed on the lower mold 7. Place the upper mold 9 on the lower mold 7 with the plate core 1 located in the upper cavity 10 of the upper mold 9, the upper mold 9 and the lower mold 7 are connected by bolts, and the shaft 3 on the plate core 1 is fixed and clamped between the upper mold 9 and the lower mold 7 with a small gap or seal, the plate core 1 does not move left and right or swing between the upper mold 9 and the lower mold 7. The gap between the upper cavity 10 of the upper mold 9 and the plate core 1 and the gap between the lower cavity 8 of the lower mold 7and the plate core 1 are that the PFA needs to cover the thickness of the surface of the plate core 1.
(3) The hopper 12 is connected to the upper mold 9, the outlet of the hopper 12 is communicated with the injection port of the upper mold 9, the PFA solid raw material is put into the hopper 12, the overall structure assembled by the hopper 12, the upper mold 9, the lower mold 7 and the plate core 1 is placed in an oven with a temperature of 320° C. for 5 h (or the heating element is used to raise the temperature of the hopper 12, the upper mold 9, the lower mold 7 and the plate core 1), and the PFA solid raw material is melted, and the overall structure is taken out from the oven, as shown in FIG. 3 and FIG. 4, the pushing mold 14 is placed on the hopper 12 of the integral structure, and the whole structure is placed on a press, and the press is hot-pressed with 10 MPa pressure, so that the PFA melt 13 in the hopper 12 flows into the injection port of the upper mold 9, the gap between the upper cavity 10 of the upper mold 9 and the outer ring of the plate core 1, the second through holes 5, the gap between the outer ring of the plate core 1 and the lower cavity 8 of the lower mold 7 and the gap between the lower cavity 8 of the lower mold 7 and the plate core 1. If the small gap of the shaft 3 is clamped between the upper mold 9 and the lower mold 7, the PFA melt 13 flows into the small gap between the shaft 3 and the upper mold 9 or the lower mold 7 during hot pressing of the press, and the melt has a certain sealing effect on the small gap, which is also convenient for subsequent vacuumizing.
(4) After the hot pressing is finished, the mold and the plate core 1 are cooled ; As shown in FIG. 3, channels 6 are provided in the two shafts 3 of the present embodiment, the channels 6 in the two shafts 3 are in communication with the first through hole 4 of the plate core 1. A temperature sensing probe is inserted into the channel 6 of plate core 1 through the channel 6 of shafts 3, the temperature sensing probe detects the temperature of the plate core 1 in real time, and when the temperature of the plate core 1 detected by the temperature sensing probe is reduced to 310-315° C. the temperature sensing probe is taken out, the channels 6 of the two shafts 3 are respectively connected to the outer connecting pipe, the channels 6 of the two shafts 3 are vacuumized through the outer connecting pipe, and the gas between the PFA melt 13 and the plate core 1 is drawn out through the expanded polytetrafluoroethylene cylindrical block 11, the channel 6 in the plate core 1, the channel 6 in the shaft 3 and the outer connecting pipe in sequence, and the outer connecting pipe is detached.
(5) Continuing to insert a telescopic temperature sensing probe into the channel 6 of the plate core 1 from the channel 6 of the shaft 3, cooling the mold and the plate core I as a whole when the temperature of the plate core 1 detected by the temperature sensing probe drops below 260° C., after cooling, removing the upper mold 9 and lower mold 7 from the outer surface of the plate core 1,removing residual PFA at the injection port, and trimming and grinding the PFA coated on the outer surface of the plate core 1 to obtain the plate core 1 with the PFA coating layer 16 on the outer surface shown in FIG. 5, FIG. 6 and FIG. 7, that is, the PFA coated butterfly plate. The thickness of the PFA coating layer 16 is 3-10 mm, and it is ensured that the product has no flow marks. A PFA coating layer 16 is also provided in the second through holes 5 of the plate core 1.

The first through hole 4 and the second through holes 5 in this embodiment are both circular holes with a diameter of 5-20 mm. The number and the arrangement of the second through holes 5 is determined according to the size, and during hot pressing, it is ensured that the material is stably injected into the lower cavity 8 from the second through holes 5.

The PFA solid raw material in this embodiment is PFA granular material or powder, the melting point is 305-310° C., the melt index (372 ° C./ 5 kg) is greater than or equal to 2 g/ 10 min, and the density is 2.13-2.15 g/cm³,

In this embodiment, the upper end face and the lower end face of the expanded polytetrafluoroethylene cylindrical block 11 are both arc convex faces, the upper end arc convex face of the expanded polytetrafluoroethylene cylindrical block 11 protrudes out of one end face of the first through hole 4 of the plate core 1, the lower end arc convex face of the expanded polytetrafluoroethylene cylindrical block 11 protrudes out of the other end face of the first through hole 4 of the plate core 1, the height of the arc convex face is 0.1 mm, and during vacuumizing, the arc convex face of the expanded polytetrafluoroethylene cylindrical block 11 facilitates air flow and extraction.

The expanded polytetrafluoroethylene cylindrical block in this embodiment can resist high temperature and do not melt, does not stick to metal and PFA, and is small in strength and easy to crush. The expanded polytetrafluoroethylene cylindrical block 11 inside the plate core 1 with the PFA coated on the outer surface can be selected to be taken out or not taken out. If it is selected to take out, the tool can be directly used to extend into the channel 6 in the shaft 3 and the channel 6 in the plate core 1, the expanded polytetrafluoroethylene cylinder block 11 is mashed by the tool, and then the mashed expanded polytetrafluoroethylene cylinder block Il is taken out from the channel 6 in the plate core 1 and the channel 6 in the shaft 3. The expanded polytetrafluoroethylene cylindrical block Il can allow airflow to pass through without passing the PFA melt during the vacuuming phase of the forming process.

The press in this embodiment adopts a one-way hot press, and the pressing speed can be controlled to be 0.05 inches/min −0.3 inches/min.

### Embodiment 2

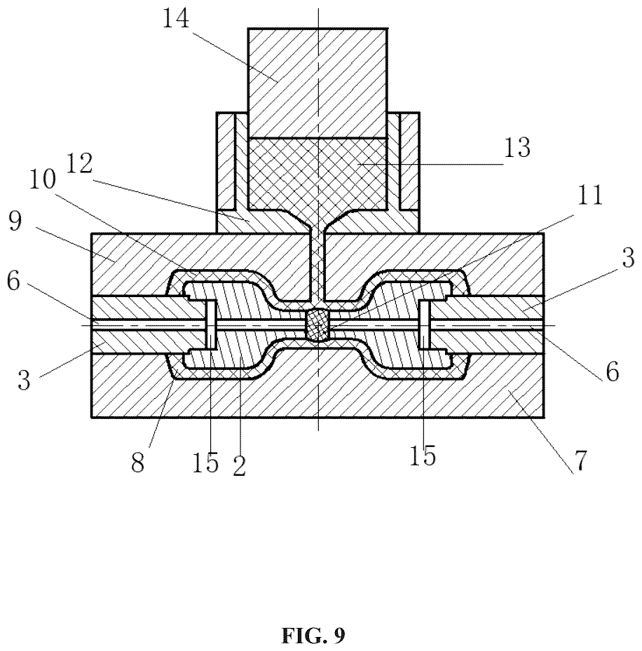

A method for forming a PFA coated butterfly plate without flow marks, comprising a mold and a circular plate core 1 (i.e. a butterfly plate) as shown in FIG. 9, the circular plate core 1 is made of a metal material such as cast iron or steel.

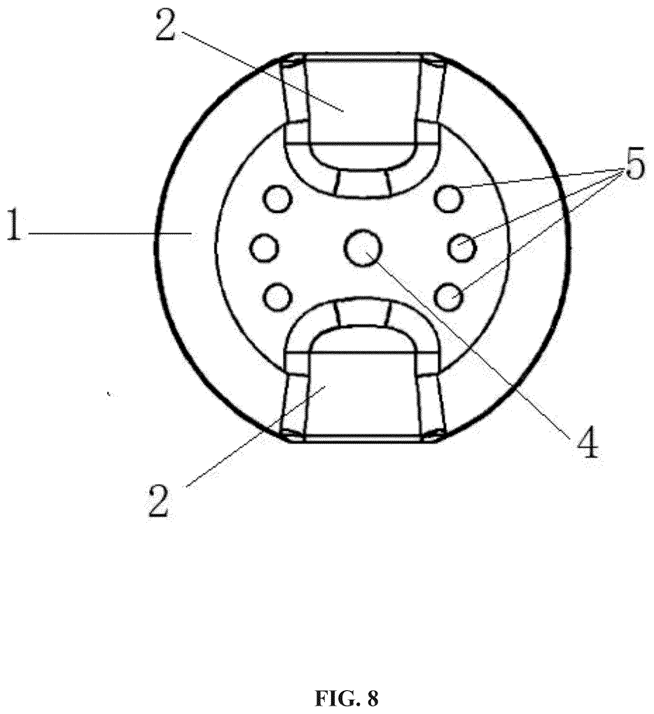

As shown in FIG. 9, the mold includes a push mold 14, a hopper 12, an upper mold 9 and a lower mold 7 ; The bottom of the upper mold 9 is provided with an upper cavity 10, the top of the lower mold 7 is provided with a lower cavity 8, the upper mold 9 is internally provided with an injection port, the injection port penetrates through the top of the upper mold 9 and the middle of the upper cavity 10 of the upper mold 9, the outlet of the hopper 12 is communicated with the injection port of the upper mold 9 when the hopper 12 is located on the upper mold 9, and the push mold 14 is placed in the hopper 12 and used for pushing the material in the hopper 12. As shown in FIG. 8, the plate core 1 is provided with two mutually symmetrical protruding structures 2, as shown in FIG. 9, the inner sides of the two protruding structures 2 are provided with mounting holes 15 (one of the mounting holes 15 is a circular hole, a tool shaft with a circular end face is provided at a corresponding insertion end, the other mounting hole 15 is a hexagonal hole, and a tool shaft with a hexagonal end face is provided corresponding to the inserting end), the mounting holes 15 of the two protruding structures 2 are both inserted with a shaft 3 (i.e. a tool shaft), and the two shafts 3 are located on the same straight line (the two shafts 3 are respectively a tool shaft with a hexagonal end face and a tool shaft with a circular end face at the end). The plate core 1 is provided with a channel 6 penetrating through the center of the plate core 1 and the mounting hole 15 in the protrusion structure 2 of the plate core 1, the shaft 3 is also provided with a channel 6. The channel 6 in the shaft 3, the mounting hole 15 of the protrusion structure 2 of the plate core 1, and the channel 6 in the plate core I are connected, the channel 6 in the plate core 1 penetrates through the center of the plate core 1.

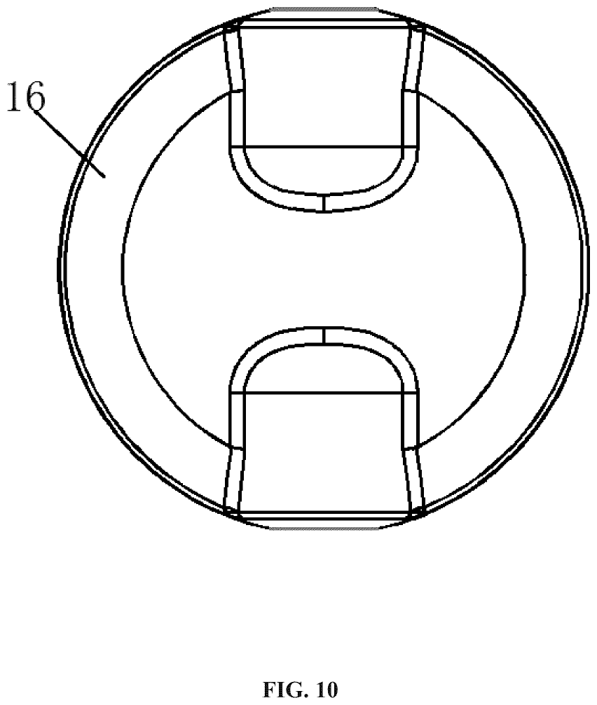

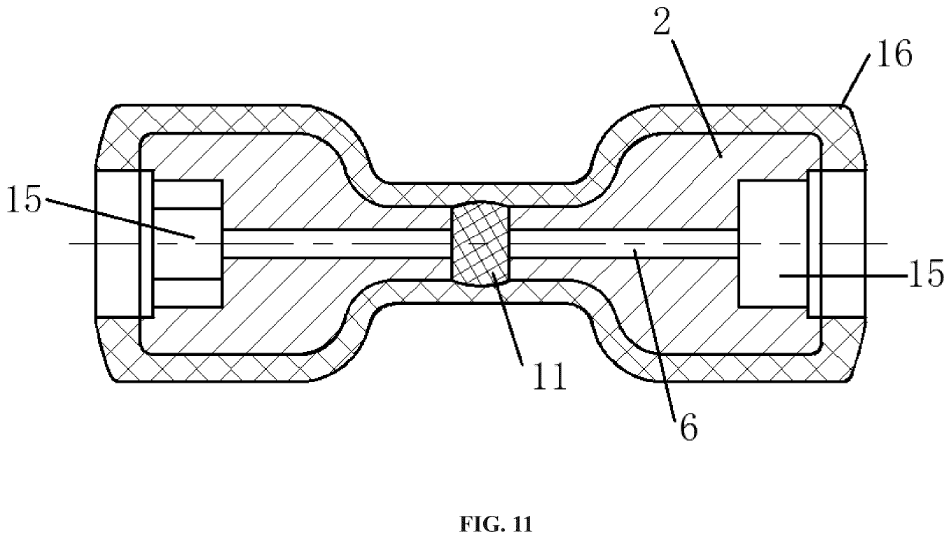

The forming method includes the following steps:
(1) A plate core 1 as shown in FIG. 8 is taken, a first through hole 4 penetrating through the upper surface and the lower surface of the plate core 1 is formed in the center position of the plate core 1, it is guaranteed that the first through hole 4 communicates with the channel 6 in the shaft 3 through the channel 6 on the plate core 1 and the mounting hole 15 of the protruding structure 2 on the plate core 1, the first through hole 4 is filled with the expanded polytetrafluoroethylene cylindrical block 11. The expanded polytetrafluoroethylene cylindrical block 11 can withstand high temperatures without melting, does not stick to metals and PFA, has low strength and is easy to crush, during the vacuum stage of the forming process, airflow can be allowed to pass through without allowing PFA melt 13 to pass through. The porosity of the expanded polytetrafluoroethylene cylinder block 11 is greater than or equal to 30%, the other positions of the plate core 1 are further provided with a plurality of second through holes 5 (similar to FIG. 1 and FIG. 2) penetrating through the upper surface and the lower surface of the plate core 1, and a channel 6 communicating with the first through hole 4 of the plate core 1 is formed in the shaft 3 ; A shaft 3 is inserted into the mounting holes 15 of the two protruding structures 2 of the plate core 1.
(2) Placing the plate core 1 into the lower cavity 8 of the lower mold 7, placing the shaft 3 inserted on the plate core 1 outside the lower cavity 8 and positioning and connecting to the top of the lower mold 7 (preventing the plate core 1 from moving left and right along the axis of the shaft 3 and swinging around the axis of the shaft 3). The upper mold 9 is placed on the lower mold 7, and the core 1 is located in the upper cavity 10 of the upper mold 9, the upper mold 9 and the lower mold 7 are connected by bolts, and the shaft 3 on the core I is clamped between the upper mold 9 and the lower mold 7 with a small gap or seal, the plate core 1 does not move left and right or swing between the upper mold 9 and the lower mold 7. The gap between the upper cavity 10 of the upper mold 9 and the plate core 1 and the gap between the lower cavity 8 of the lower mold 7 and the plate core 1 being the thickness of PFA needing to be coated on the surface of the plate core 1.
(3) The hopper 12 is connected to the upper mold 9, the outlet of the hopper 12 is communicated with the injection port of the upper mold 9, the PFA solid raw material is put into the hopper 12, the overall structure assembled by the hopper 12, the upper mold 9, the lower mold 7 and the plate core 1 is placed in an oven with a temperature of 380° C. for 2 h (or the heating element is used to raise the temperature of the hopper 12, the upper mold 9, the lower mold 7 and the plate core 1), the PFA solid raw material is melted, and the overall structure is taken out from the oven, the pushing mold 14 is placed on the hopper 12 of the integral structure, and the whole structure is placed on a press, and the press is hot-pressed with 10 MPa pressure, the press mold 14 applies pressure to the material in the hopper 12, so that the PFA melt 13 in the hopper 12 flows into the injection port of the upper mold 9, the gap between the upper cavity 10 of the upper mold 9 and the plate core 1, the second through holes 5, the gap between the outer ring of the plate core I and the upper cavity 10 of the upper mold 9, the gap between the outer ring of the plate core 1 and the lower cavity 8 of the lower mold 7, and the gap between the lower cavity 8 of the lower mold 7 and the plate core 1. Since the small gap of the shaft 3 on the plate core 1 is clamped between the upper mold 9 and the lower mold 7, during hot pressing of the press, the PFA melt 13 flows into the small gap between the shaft 3 and the upper mold 9 or the lower mold 7, and the melt has a certain sealing effect on the small gap, which is also convenient for subsequent vacuumizing.
(4) After the hot pressing is finished, the mold and the plate core 1 are cooled ; the channels 6 are provided in the two shafts 3 of the present embodiment, the channels 6 in the two shafts 3 are in communication with the first through hole 4 of the plate core 1 through the mounting holes 15 of the two protruding structures 2 and the channel 6 of plate core 1. A temperature sensing probe is inserted into the channel 6 of plate core 1 through the channel 6 of a shaft 3, the temperature sensing probe detects the temperature of the plate core 1 in real time, after the temperature of the plate core 1 detected by the temperature sensing probe is reduced to 310-315° C. the temperature sensing probe is taken out, the channels 6 of the two shafts 3 are respectively connected to the external connecting pipe, the channels 6 of the two shafts 3 are vacuumized through the external connecting pipe at the same time, and the gas between the PFA melt 13 and the plate core 1 is drawn out through the expanded polytetrafluoroethylene cylindrical block 11, the channel 6 in the plate core 1, the channel 6 in the shafts 3 and the external connecting pipe in sequence, and the external connecting pipe is disassembled.
(5) Continuing to insert a telescopic temperature sensing probe into the channel 6 of the plate core 1 from the channel 6 of the shaft 3, cooling the mold and the plate core 1 as a whole when the temperature of the plate core I detected by the temperature sensing probe drops below 260° C., after cooling, removing the upper mold 9 and lower mold 7 from the outer surface of the plate core 1, removing residual PFA at the injection port, and trimming and grinding the PFA coated on the outer surface of the plate core I to obtain the plate core 1 with the PFA coating layer 16 on the outer surface shown in FIG. 10, FIG. 11 and similar FIG. 6, that is, the PFA coated butterfly plate. The thickness of the PFA coating layer 16 is 3-10 mm to ensure that the product is free of flow marks.
Then, the tool shafts (i.e. shafts 3) at both ends of the butterfly plate are detached, the structure diagram after the tool shaft is disassembled is shown in FIG. 11, the tool shaft is made of a metal material, and PFA is not bonded to the metal, the tool shaft is pulled out from the butterfly plate. When in use, the valve shaft is loaded into the mounting holes 15 at both ends of the butterfly plate.

The first through hole 4 and the second through holes 5 in this embodiment are both circular holes with a diameter of 5-20 mm. The number and the arrangement of the second through holes 5 is determined according to the size of the second through holes 5, and during hot pressing, it is ensured that the material is stably injected into the lower cavity 8 from the second through holes 5.

The PFA solid raw material in this embodiment is PFA granular material or powder, the melting point is 305-310° C., the melt index (372 ° C/5 kg) is greater than or equal to 2 g/ 10 min, and the density is 2.13-2.15 g/cm³.

In this embodiment, the upper end face and the lower end face of the expanded polytetrafluoroethylene cylindrical block 11 are both arc convex faces, the upper end arc convex face of the expanded polytetrafluoroethylene cylindrical block 11 protrudes out of one end face of the first through hole 4 of the plate core 1, the lower end arc convex face of the expanded polytetrafluoroethylene cylindrical block 11 protrudes out of the other end face of the first through hole 4 of the plate core 1, the height of the arc convex face is 1 mm, and during vacuumizing, the arc convex face of the expanded polytetrafluoroethylene cylindrical block 11 facilitates air flow and extraction.

The expanded polytetrafluoroethylene cylindrical block in this embodiment can resist high temperature and do not melt, does not stick to metal and PFA, and is small in strength and easy to crush. The expanded polytetrafluoroethylene cylindrical block 11 inside the plate core 1 with the PFA coated on the outer surface can be selected to be taken out or not taken out. If it is selected to take out, the tool can be directly used to extend into the channel 6 in the shaft 3 and the channel 6 in the plate core 1, the expanded polytetrafluoroethylene cylinder block 11 is mashed by the tool, and then the mashed expanded polytetrafluoroethylene cylinder block 11 is taken out from the channel 6 in the plate core 1 and the channel 6 in the shaft 3. The expanded polytetrafluoroethylene cylindrical block 11 can allow airflow to pass through without passing the PFA melt during the vacuuming phase of the forming process.

In this embodiment, a one-way hot press is adopted in the press, and the pressing speed can be controlled to be 0.05 inches/min −0.3 inches/min.

The protection scope of the present invention includes but is not limited to the above embodiments, the protection scope of the present invention is subject to the claims, and any substitution, deformation and improvement which would be easily conceived of by a person skilled in the art made by the present technology fall within the protection scope of the present invention.

What is claimed is:

1. A method for forming a PFA coated butterfly plate without flow marks, comprising a mold and a plate core;
the mold comprises a push mold, a hopper, an upper mold and a lower mold; the bottom of the upper mold is provided with an upper cavity, the top of the lower mold is provided with a lower cavity, the upper mold is internally provided with an injection port, the injection port penetrates through the top of the upper mold and the middle of the upper cavity of the upper mold, when the hopper is located on the upper mold, the outlet of the hopper is in communication with the injection port of the upper mold, and the push mold is placed in the hopper and used for pushing the material in the hopper;
two mutually symmetrical protruding structures are arranged on the plate core, shafts are connected to the two protruding structures, the two shafts are located on the same straight line, channels communicating with each other are formed in the plate core and the shaft, and the channel penetrates through the center of the plate core;
the forming method includes the following steps:
a plate core is taken, a first through hole penetrating through the upper surface and the lower surface of the plate core is formed in the center of the plate core, the first through hole is communicated with a channel in the plate core, an expanded polytetrafluoroethylene cylindrical block is inserted into the first through hole, and a plurality of second through holes penetrating through the upper surface and the lower surface of the plate core are further formed in other positions of the plate core;
placing the plate core into the lower cavity of the lower mold, placing the shaft connected on the plate core outside the lower cavity and connected to the top of the lower mold, placing the upper mold on the lower mold, the plate core being located in the upper cavity of the upper mold, connecting the upper mold to the lower mold, the shaft on the plate core being clamped between the upper mold and the lower mold, and the gap between the upper cavity of the upper mold and the plate core and the gap between the lower cavity of the lower mold and the plate core being the thickness of PFA needing to be coated on the surface of the plate core;
the hopper is connected to the upper mold, the outlet of the hopper is in communication with the injection port of the upper mold, the overall structure assembled by the hopper, upper mold, lower mold and plate core is heated to melt the PFA raw material in the hopper, and after the heating is finished, the push mold is placed in the hopper of the overall structure, the pressing machine performs hot pressing on the push mold, and the push mold applies pressure to the material in the hopper, so that the PFA raw material in the hopper flows into the injection port of the upper mold, the gap between the upper cavity of the upper mold and the plate core, the second through holes and the gap between the lower cavity of the lower mold and the plate core;
after the hot pressing is finished, cooling the mold and the plate core, connecting the channel in the shaft connected with the plate core to the outer connecting pipe after the plate core falls to the preset temperature, vacuumizing the outer connecting pipe, and pumping out the gas between the PFA raw material and the plate core through the expanded polytetrafluoroethylene cylindrical block, the channel in the plate core, the channel in the shaft and the outer connecting pipe in sequence, and disassembling the outer connecting pipe;
after the plate core is cooled to a certain temperature, the mold and the plate core are integrally cooled, the upper mold and the lower mold at the outer side of the plate core are removed after cooling, the residual PFA at the injection port is removed, and PFA coated on the outer surface of the plate core is trimmed and polished to obtain the PFA coated butterfly plate.

2. The method for forming the PFA coated butterfly plate without flow marks according to claim 1, wherein: the two protruding structures on the plate core are of a solid structure, the protruding structures on the plate core and the shaft are of an integrated structure, and a channel in the plate core penetrates through the protruding structure and then communicates with a channel in the shaft.

3. The method for forming the PFA coated butterfly plate without flow marks according to claim 1, wherein: the inner sides of the two protruding structures on the plate core are provided with mounting holes, the shaft is a tool shaft, the two tool shafts are inserted into the mounting holes of the two protruding structures on the plate core respectively, and the first through hole in the plate core are communicated with the channel in the tool shaft through the channel on the plate core and the mounting hole of the protruding structure on the plate core.

4. The method for forming the PFA coated butterfly plate without flow marks according to claim 2, wherein: the first through hole and the second through holes are both circular holes with a diameter of 5-20 mm.

5. The method for forming the PFA coated butterfly plate without flow marks according to claim 3, wherein: the PFA solid raw material is PFA granular material or powder, the melting point is 305-310° C. the melt index is greater than or equal to 2 g/10 min, and the density is 2.13-2.15 g/cm^{3.}

6. The method for forming the PFA coated butterfly plate without flow marks according to claim 2, wherein: the overall structure assembled by the hopper, the upper mold, the lower mold and the plate core is heated specifically as follows:
the overall structure of the hopper, the upper mold, the lower mold and the plate core is placed into an oven for heat preservation for a period of time, the temperature of the oven is 320-380° C. and the heat preservation time is 2-5 h.

7. The method for forming the PFA coated butterfly plate without flow marks according to claim 3, wherein: the press performs hot pressing on the push mold by using a pressure of 6-10 MPa.

8. The method for forming the PFA coated butterfly plate without flow marks according to claim 2, wherein: after the hot pressing is finished, the mold and the plate core are cooled, and after the plate core is reduced to 310° C. to 315° C. the channel in the shaft connected to the plate core is connected to the outer connecting pipe to vacuumize the outer connecting pipe.

9. The method for forming the PFA coated butterfly plate without flow marks according to claim 8, wherein: the temperature of the plate core is reduced to below 260° C. and the mold and the plate core are integrally cooled.

10. The method for forming the PFA coated butterfly plate without flow marks according to claim 3, wherein: the porosity of the expanded polytetrafluoroethylene cylindrical block is greater than or equal to 30%, the upper end face and the lower end face of the expanded polytetrafluoroethylene cylindrical block are both arc convex faces, the upper end face of the expanded polytetrafluoroethylene cylindrical block protrudes out of one end face of the first through hole of the plate core, and the lower end face of the expanded polytetrafluoroethylene cylindrical block protrudes out of the other end face of the first through hole of the plate core.
